(19) United States
(12) Patent Application Publication
(10) Pub. No.: US 2008/0288325 A1
(43) Pub. Date: Nov. 20, 2008

(54) System and Method for Providing Information Regarding a Redirection of an Internet User to a Webpage

(75) Inventor: Dmitry Yurievich Pavlov, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/748,719

(22) Filed: May 15, 2007

(51) Int. Cl. G06Q 30/00; G06Q 10/00

(52) U.S. Cl. 705/10; 705/14

(57) ABSTRACT

Systems and methods for providing information related to a redirection of a user to a webpage are disclosed. In one implementation, an ad provider serves a digital ad in response to a digital ad request. A user navigation event, such as a click-through, related to the served digital ad is detected and information related to at least one of the serving of the digital ad and a user associated with the user navigation event is passed to an advertiser system that presents the user with a webpage associated with the digital ad. The advertiser system may modify, or dynamically create, the webpage presented to the user based on the received information.

### BACKGROUND

Online advertisement service providers (“ad providers”), such as Yahoo! Search Marketing, often provide advertisers with the ability to dynamically create a digital ad, such as a sponsored search listing. The digital ad may be served based on keywords received by the ad provider. For example, when an ad provider receives a digital ad request and associated keyword, the ad provider may provide advertisers the ability to have a digital ad served with the associated keyword inserted into a title of the digital ad, or the body of the digital ad. When an Internet user clicks-through (“clicks”) on a served digital ad, the Internet user is redirected to a webpage, also known as a landing page, associated with the digital ad. However, other than the keyword that caused the digital ad to be served, the advertiser does not receive information regarding the Internet user, the context in which the ad provider matched the keyword with the digital ad, and/or whether the match between the keyword and the digital ad was an exact match or an approximate match. Advertisers may desire this type of information regarding the click-through on the digital ad to increase to increase the possibility of completing a conversion.

### BRIEF DESCRIPTION OF THE DRAWINGS

FIG. 1 is a block diagram of one embodiment of an environment in which a system for providing information regarding a redirection of an Internet user to a webpage may operate;

FIG. 2 is a block diagram of one embodiment of a system for providing information regarding a redirection of an Internet user to a webpage;

FIG. 3 is a flow chart of one embodiment of a method for providing information regarding a redirection of an Internet user to a webpage; and

FIG. 4 is a flow chart of another embodiment of a method for providing information regarding a redirection of an Internet user to a webpage.

### DETAILED DESCRIPTION OF THE DRAWINGS

The present disclosure is directed to systems and methods for providing information regarding a redirection of an Internet user to a webpage. Providing an advertiser with information regarding a redirection of an Internet user to their webpage allows the advertiser to modify a webpage presented to the Internet user. The modified webpage may better target the webpage to interests of the Internet user and increase the potential to complete a conversion. For example, the advertiser may modify a webpage presented to the Internet user based on one or more demographics of the Internet user. In addition or alternatively, the advertiser may modify a webpage based on one or more properties related to a redirection such as a keyword that resulted in a digital ad being served to the Internet user.

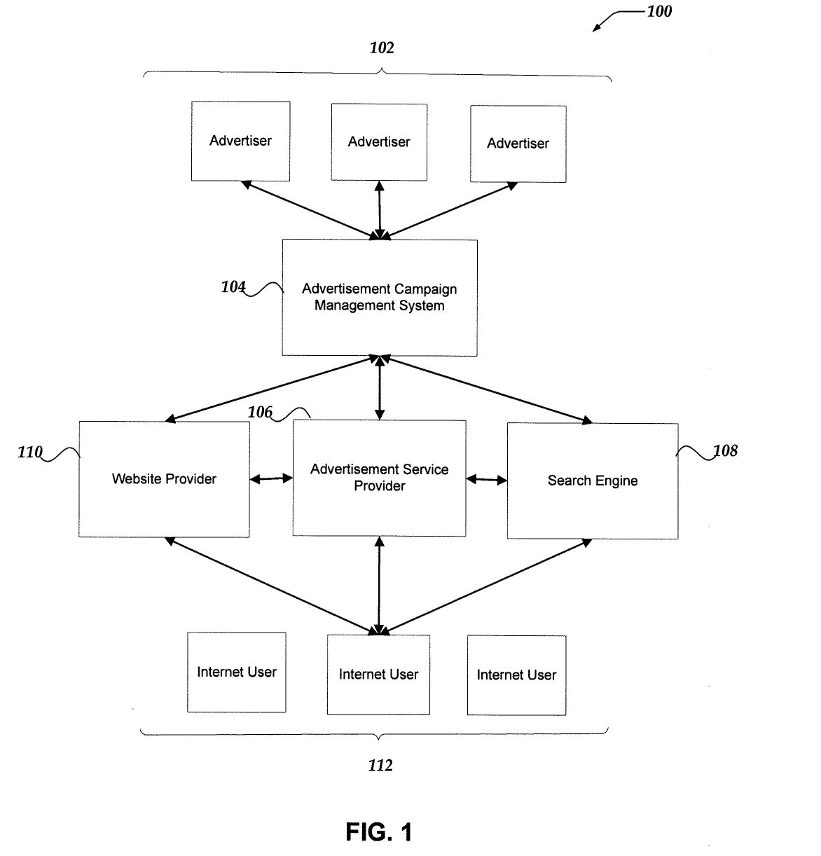

FIG. 1 is a block diagram of one embodiment of an environment in which a system for providing information regarding a redirection of an Internet user to a webpage may operate. However, it should be appreciated that the systems and methods described below are not limited to use with a search engine or pay-for-placement online advertising.

The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may pay additional premiums for certain targeting options, such as targeting by demographics, geography, or context. The digital ad may be a graphical banner ad that appears on a website viewed by Internet users 112, a sponsored search listing that is served to an Internet user 112 in response to a search performed at the search engine 108, a video ad, a graphical banner ad based on a sponsored search listing, and/or any other type of online marketing media.

When an Internet user 112 performs a search at a search engine 108, the search engine 108 may return a plurality of search listings to the Internet user. The ad provider 106 may serve one or more digital ads to the Internet user 112 based on search terms provided by the Internet user 112. In addition or alternatively, an Internet user 112 views a website served by the website provider 110, the ad provider 106 may serve one or more digital ads to the Internet user 110 based on keywords obtained from the content of the website.

When the search listings and digital ads are served, the ad campaign management system 104, the ad provider 106, and/or the search engine 108 may record and process information associated with the served search listings and digital ads for purposes such as billing, reporting, or ad campaign optimization. For example, the ad campaign management system 104, ad provider 106, and/or search engine 108 may record the search terms that caused the search engine 108 to serve the search listings; the search terms that caused the ad provider 106 to serve the digital ads; whether the Internet user 112 clicked on a URL associated with one of the search listings or digital ads; what additional search listings or digital ads were served with each search listing or each digital ad; a rank of a search listing when the Internet user 112 clicked on the search listing; a rank or position of a digital ad when the Internet user 112 clicked on a digital ad; and/or whether the Internet user 112 clicked on a different search listing or digital ad when a digital ad, or a search listing, was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference.

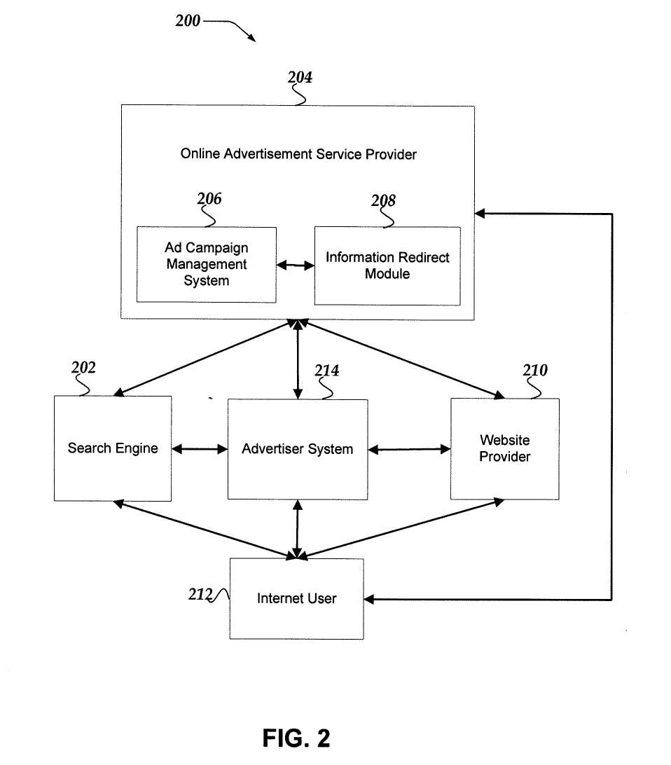

FIG. 2 is a block diagram of one embodiment of a system for providing information regarding a redirection of an Internet user to a webpage. The system 200 may include a search engine 202, an ad provider 204, an ad campaign management system 206, an information redirect module 208, and a website provider 210. In some implementations the ad campaign management system 206 may be part of the ad provider 204, or the information redirect module 208 may be part of the search engine 202 or the ad provider 204. In other implementations, the ad campaign management system 206 and/or the information redirect module 208 may be distinct from both the search engine 202 and the ad provider 205.

The search engine 202, ad provider 204, ad campaign management system 206, information redirect module 208, and website provider 210 may communicate with each other over one or more external or internal networks. The networks may include local area networks (LAN), wide area networks (WAN), and the Internet, and may be implemented with wireless or wired communication mediums such as wireless fidelity (WiFi), Bluetooth, landlines, satellites, and/or cellular communications.

The search engine 202, ad provider 204, ad campaign management system 206, information redirect module 208, and website provider 210 may be implemented as hardware, firmware, and/or software code running in conjunction with a processor such as a single server, a plurality of servers, or any other computing device known in the art.

Generally, an Internet user 212 interacts with the search engine 202 or the website provider 210, resulting in the ad provider 204 receiving a digital ad request. The ad provider 204 serves one or more digital ads to the Internet user 212. The search engine 202, ad provider 204, and/or website provider 210 detects a user navigation event related to at least one of the served digital ads such as the Internet user 212 clicking on a served digital ad. In response to the user navigation or other event, the Internet user 212 is redirected to a new webpage, also known as a landing page, associated with the digital ad.

When the Internet user 212 is redirected to the new webpage, the information redirect module 208 may additionally pass information regarding the redirection of the Internet user 212 to an advertiser system 214 that provides the new webpage to the Internet user 212. For example, the information redirect module 208 may pass demographic information such as an age, gender, occupation, geographic location, income level, any targeting modeling on the user, such as behavioral targeting, demographic targeting, or geographic targeting, or any other information regarding the Internet user 212 known by the search engine 202, ad provider 204, and/or website provider 210 to the advertiser system 214. Information regarding the Internet user 212 may be determined based on various types of information sources such as cookies stored on the system of the Internet user 212; information provided by the Internet user 212 when the Internet user 112 because a “registered user” with the search engine 202, ad provider 204, and/or website provider 210; or any other means for obtaining information regarding an Internet user.

The information redirect module 208 may additionally pass information regarding the redirection of the Internet user 212 such as the keyword that a digital ad was served in response to; one or more previous keywords associated with digital ad requests received from the same Internet user 212; what other digital ads were shown to the Internet user 212; one or more search listings associated with the keyword that the digital was served in response to; key topics related to search listings associated with the keyword that the digital ad was served in response to, or any other information that may be helpful to the advertiser system 214 in tailoring a webpage to the interests of the Internet user 212.

In some implementations, by interacting with the ad campaign management system 206, an advertiser may set one or more information preferences associated with information to be passed to the advertiser when the Internet user 212 is redirected to a webpage provided by the advertiser system 214. For example, the advertiser may choose to receive information regarding the gender and age of the Internet user 212, but not to receive information regarding the occupation or income of the Internet user 212. In another example, the advertiser may choose to receive information regarding the keyword that a digital ad was served in response to, but not to receive information regarding other digital ads that were displayed to the Internet user 212.

Based on the passed information regarding the redirection of the Internet user 212, the advertiser system 215 may modify an existing webpage to present to the Internet user 212, or the advertiser system 215 may select one or more applications to execute to dynamically create a webpage to present to the Internet user 212. For example, if the advertiser system 215 is passed information regarding a location of the Internet user 212, the advertiser system 215 may modify, or dynamically create, the new webpage to present content that is relevant to the location of the Internet user 212. In one implementation, the advertiser system 215 may dynamically create a webpage that includes products and services that are actually available in the location of the Internet user 112, or the advertiser system 215 may dynamically create the webpage to include directions to stores that are located near the Internet user 112.

Similarly, if the advertiser system 215 is passed information regarding an age and gender of the Internet user 212, the advertiser system 215 may dynamically create the new webpage in a manner that has resulted in other users of the same age and gender purchasing a product or service. For example, the advertiser system 215 may choose to execute one or more applications to add hyperlinks to one or more products or services that may be of interest to a user of a particular age and gender, to orientate a webpage in a manner that has proven effective in selling products or services to a user of a particular age and gender, to include graphics that may be of interest to a user of a particular age and gender, or any other action used to create a webpage that may be of interest to a user of a particular age and gender.

Two methods for passing information regarding the redirection of an Internet user 212 to a webpage are described below. In a first implementation, the information redirect module 208 passes information to the advertiser system 214 after the user clicks on a digital ad. In a second implementation, before a digital ad is served to the Internet user 212, the information redirect module 208 embeds information in a uniform resource locator (“URL”) associated with the digital ad. Therefore, when the Internet user 212 clicks on the digital ad, information regarding the redirection of the Internet user 212 that is embedded in the URL is passed to the advertiser system.

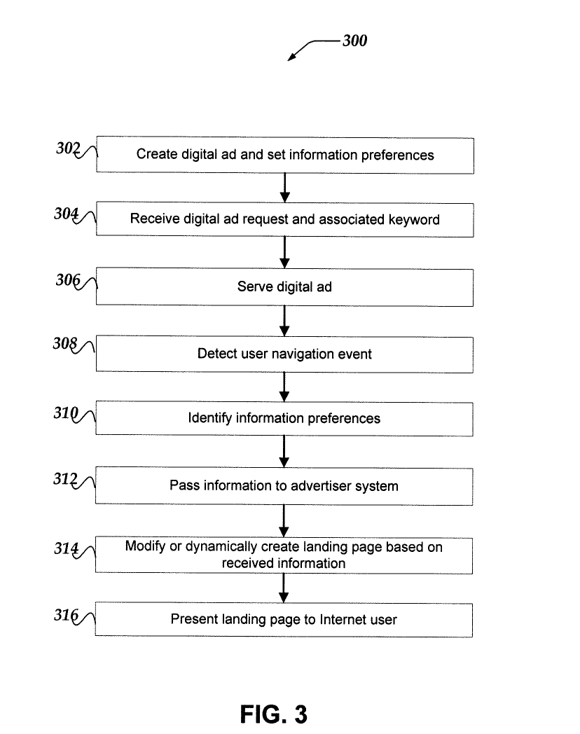

FIG. 3 is a flow chart of one embodiment of a method 300 for providing information regarding a redirection of an Internet user to a webpage where an information redirect module passes information to an advertiser system after the Internet user clicks on a digital ad. At step 302 an advertiser interacts with an ad campaign management system of an ad provider to create a digital ad and set information preferences associated with the digital ad. The digital ad may be a sponsored search listing, a graphical banner ad, a graphical banner ad based on a textual offer, a video ad, or any other media. The information preferences may be one or more settings that indicate what type of information related to a redirection of an Internet user to a landing page associated with the digital ad that the advertiser would like to receive and would not like to receive. For example, the advertiser may desire to receive one or more demographic properties associated with the Internet user and to receive a keyword that caused the digital ad to be served.

The ad provider receives a digital ad request and associated keyword at step 304. The digital ad request may be received from an Internet search engine based on a received search query, from a website provider based on the content of a webpage, or from any other media serving provider operable to serve digital ads to devices such as a personal computer, a cellular telephone, a mobile device, or any other computing device. Based on the keyword, at step 306, the ad provider serves the digital ad created at step 302 to the Internet user.

The search engine, ad provider, and/or website provider detects a user navigation event associated with the served digital ad at step 308. The user navigation event may be the Internet user clicking on the digital ad, or any other user navigation event.

In some implementations, after detecting the user navigation event, at step 310, an information redirect module identifies the one or more information preferences associated with the digital ad that have been set by the advertiser. Based on the one or more information preferences, at step 312, the information redirect module passes information to an advertiser system that presents the landing page associated with the digital ad to the Internet user. As discussed above, the information redirect module may pass information such as demographic information associated with the Internet user, a keyword associated with the digital ad, other digital ads that were presented to the Internet user, a category of a search query associated with the digital ad request, or any other type of information that may be useful to an advertiser in targeting a webpage to the Internet user. In other implementations, the information redirect module passes information to an advertiser system that presents the landing page associated with the digital ad to the Internet user regardless of any information preferences set by the advertiser. It should be appreciated that typically, the information direct module does not pass information to the advertiser system that is in conflict with privacy policies of the ad provider.

The advertiser system receives the information regarding the redirection of the Internet user at step 314, and modifies, or dynamically creates, the landing page to present to the Internet user based on the received information regarding the redirection of the Internet user. The advertiser system then presents the landing page to the Internet user at step 316.

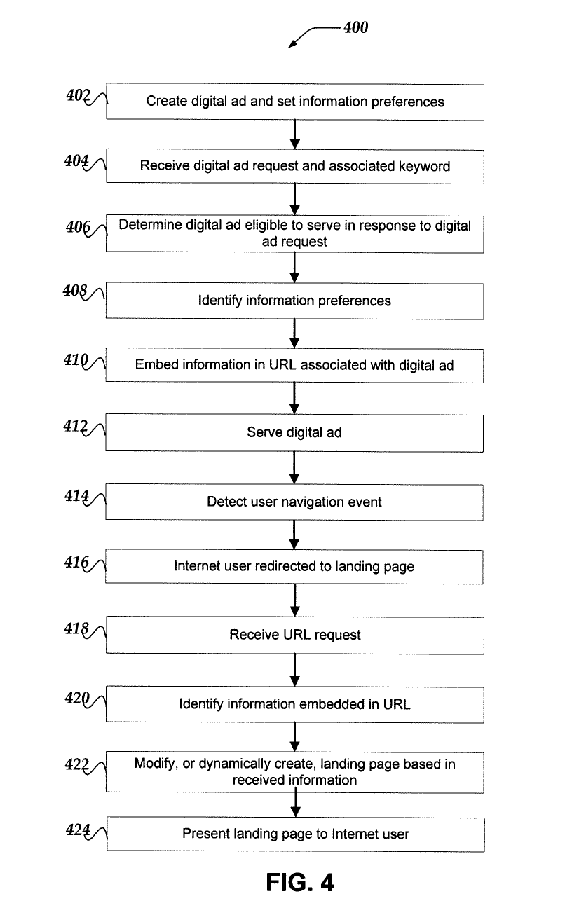

FIG. 4 is a flow chart of another embodiment of a method for providing information regarding a redirection of an Internet user to a webpage where an information redirect module embeds information in a URL associated with a digital ad. The method 400 beings at step 402 with an advertiser interacting with an ad campaign management system of an ad provider to create a digital ad and set information preferences associated with the digital ad.

The ad provider receives a digital ad request and associated keyword at step 404. Based on the keyword, at step 406, the ad provider determines the digital ad is eligible to serve to the Internet user in response to the digital ad request. In some implementations, after determining the digital ad is eligible to serve to the Internet user in response to the digital ad request, at step 408, the information redirect module identifies one or more information preferences associated with the digital ad that have been set by the advertiser. Based on the information preferences, at step 410, the information redirect module embeds information such as demographic information associated with the Internet user or properties identifying why the digital ad was served in response to the digital ad request into the URL associated with the digital ad. Therefore, as explained in more detail below, if a user clicks on the digital ad and is redirected to a landing page of the URL associated with the digital ad, the information embedded in the URL of the digital ad is automatically passed to the advertiser system without additional actions by the information redirect module. It should be appreciated that in other implementations, after determining the digital ad is eligible to serve to the Internet user in response to the digital request, the information redirect module embeds information into the URL regardless of information preferences of the advertiser.

The ad provider serves the digital ad with the URL containing embedded information at step 412. The search engine, ad provider and/or website provider detects a user navigation event associated with the served digital ad at step 414 and the Internet user is redirected to the advertiser system for presentation of the landing page at step 416.

The advertiser system receives the URL request associated with the digital ad at step 418 and identifies the information embedded in the URL regarding the redirection of the Internet user at step 420. Based on the information regarding the redirection of the Internet user, the advertiser system modifies, or dynamically creates, the landing page to present to the Internet user at step 422. The advertiser system then presents the landing page to the Internet user at step 424.

FIGS. 1-4 disclose systems and methods for providing information regarding a redirection of an Internet user to a webpage. Providing an advertiser with information regarding a redirection of an internet user to their webpage allows the advertiser to modify a webpage presented to the Internet user to better target the webpage to the interests of the Internet user and increase the potential to complete conversion. In some implementations, an ad provider may charge an advertiser a premium to receive information regarding a redirection of an Internet user to a webpage. For example, in addition to any amount an advertiser has agreed to compensate an ad provider for serving their graphical banner ad or agreed to compensate an ad provider for an Internet user clicking on a served sponsored search listing, the advertiser may agree to compensate the ad provider a predetermined amount based on the type of information provided to the advertiser regarding a redirection of an Internet user to a webpage. For example, the advertiser may agree to pay an ad provider a first amount if an age of an Internet user is provided to the advertiser and agree to pay the ad provider a second amount of the age and gender of the Internet user us provided to the advertiser. It will be appreciated that the ad provider may create any type of tier structure for an advertiser to pay the ad provider based on the amount of information the ad provider is able to provide the advertiser regarding a redirection of an internet user to a webpage.

It is therefore intended that the foregoing detailed description be regarded as illustrative rather than limiting, and that it be understood that it is the following claims, including all equivalents, that are intended to define the spirit and scope of this invention.

1. A method for providing information related to a redirection of a user to a webpage, the method comprising:
serving a digital ad in response to a digital ad request;
detecting a user navigation event related to the digital ad, the user navigation event associated with a user; and
in response to detecting the user navigation event, passing information to an advertiser system that presents a webpage associated with the digital ad to the user, the information related to at least one of the serving of the digital ad and the user.

2. The method of claim 1, wherein the digital ad comprises a sponsored search listing.

3. The method of claim 1, wherein the digital ad comprises a graphical banner ad.

4. The method of claim 1, wherein the digital ad comprises a graphical banner ad based on a textual offer.

5. The method of claim 1, wherein the user navigation event comprises a click through.

6. The method of claim 1, wherein passing information to the advertiser system comprises:
identifying one or more information preferences associated with the advertiser system; and
identifying information to pass to the advertiser system based on the one or more information preferences.

7. The method of claim 6, further comprising:
receiving one or more information preferences from an advertiser associated with the digital ad.

8. The method of claim 1, wherein the information passed to the advertiser system comprises at least one of an age of a user, a gender of the user, an occupation of the user, an income of the user, and a geographic location associated with the user.

9. The method of claim 1, wherein the information passed to the advertiser system comprises a keyword associated with the digital ad request.

10-11. (canceled)

12. A system for providing information related to a redirection of a user to a webpage, the system comprising:
an online advertisement service provider operative to receive a digital ad request, to serve a digital ad in response to the digital ad request, and to detect a user navigation event related to the digital ad, the user navigation event associated with a user; and
an information redirect module in communication with the online advertisement service provider, the information redirect module operative to, in response to the detection of the user navigation event, pass information to an advertiser system that presents a webpage associated with the digital ad to the user, the information related to at least one of the serving of the digital ad and the user.

13. The system of claim 12, wherein the information redirect module is further operative to receive one or more information preference from an advertiser and identify information to pass to the advertiser system based on the one or more information preferences of the advertiser.

14. A method for providing information related to a redirection of a user to a webpage, the method comprising:
receiving a digital ad request, the digital ad request associated with a user;
identifying a digital ad that is eligible to be served in response to the digital ad request;
embedding information related to least one of the digital ad request and the user in a uniform resource locator (“URL”) associated with the digital ad; and
serving the digital ad associated with the URL comprising embedded information to the user.

15. The method of claim 14, wherein the digital ad comprises a sponsored search listing.

16. The method of claim 14, wherein the digital ad comprises a graphical banner ad.

17. The method of claim 14, wherein the digital ad comprises a graphical banner ad based on a textual offer.

18. The method of claim 14, wherein embedding information related to least one of the digital ad request and the user in a URL associated with the digital ad comprises:
identifying one or more information preferences associated with an advertiser associated with the digital ad; and
identifying information to embed in the URL based on the one or more information preferences.

19. The method of claim 18, further comprising:
receiving one or more information preferences from the advertiser associated with the digital ad.

20. A computer-readable storage medium comprising a set of instructions for providing information related to a redirection of a user to a webpage, the set of instructions to direct a process or perform acts of:
receiving a digital ad request, the digital ad request associated with a user;
identifying a digital ad that is eligible to be served in response to the digital ad request;
embedding information related to least one of the digital ad request and the user in a uniform resource locator (“URL”) associated with the digital ad; and
serving the digital ad associated with the URL comprising embedded information to the user.

21. The computer-readable storage medium of claim 20, further comprising a set of instructions to direct a processor to perform acts of:
receiving one or more information preferences from an advertiser associated with the digital ad; and
identifying information to embed in the URL associated with the digital ad based on the one or more information preferences of the advertiser.

22. A system for providing information related to a redirection of a user to a webpage, the system comprising:
an online advertisement service provider operative to receive a digital ad request associated with a user, to identify a digital ad that is eligible to be served in response to the digital ad request, and to serve the digital ad; and
a redirection module in communication with the online advertisement service provider, the redirection module operative to embed information related to at least one of the digital ad request and the user in a universal resource locator (“URL”) associated with the digital ad before the digital ad is served.

23. The system of claim 22, wherein the redirection module is further operative to receive one or more information preferences from an advertiser associated with the digital ad and to identify information to embed in the URL associated with the digital ad based on the one or more information preferences of the advertiser.
